(19) United States
(12) Patent Application Publication
(10) Pub. No.: US 2020/0391984 A1
(43) Pub. Date: Dec. 17, 2020

(54) Actuating Device for a Winch, and Winch

(71) Applicant: Uwe Stemmler, Altrip (DE)

(72) Inventor: Uwe Stemmler, Altrip (DE)

(21) Appl. No.: 16/764,231

(22) PCT Filed: Nov. 7, 2018
(86) PCT No.: PCT/EP2018/000507

§ 371 Date: May 14, 2020

(30) Foreign Application Priority Data
Nov. 15, 2017 (DE) 10 2017 010 564.2

(51) Int. Cl. B66D 1/74

(52) U.S. Cl. CPC B66D 1/7431; B66D 1/7468

(57) ABSTRACT

An actuating device is provided for a manually actuatable winch for operating a line. A first end of an actuating lever is configured for interaction with the winch, and the actuating lever is substantially elongate. A line deflection element is mounted on the actuating lever at a predeterminable distance from the first end of the actuating lever. Here, the actuating lever is connected to a resetting device by means of which a predeterminable force is exerted in a predeterminable direction on the actuating lever. A winch may be provided with the actuating device interconnected therewith.

### CROSS-REFERENCE TO RELATED APPLICATION(S)

This application is the U.S. national phase of PCT Application No. PCT/EP2018/000507 filed on 7 Nov. 2018, which claims priority to German Patent Application No. 10 2017 010 564.2 filed on 15 Nov. 2017, the disclosures of which are incorporated in their entirety by reference herein.

### TECHNICAL FIELD

The disclosure relates to winches and more particularly to an actuating device for a manually actuable winch for operating a line, wherein a first end of an actuating lever is configured to cooperate with the winch, and wherein the actuating lever is substantially elongate.

### BACKGROUND

It is well known that winches—which are also referred to as windlasses—are used to apply tractive forces to a line. Especially on boats, for example sailboats, winches are used for operating lines, for example sheets, halyards, other ropes of the running rigging, or other rigging lines. There are a number of different winch types, for example single-speed, two-speed or multi-speed winches, which have more or less complicated winch transmissions. A winch can be motor-operated or manually actuated.

A particularly frequently used winch type is the single-speed manually operated winch for sailboats. In this case, in order to operate a winch, the rope to be operated is generally laid with several coils around a winch drum and the winch drum is rotated using a winch crank. The rope running onto the winch drum is pulled by the winch. An operator of the winch also has to hold the rope running off the winch drum under tension at least with one hand, in order to maintain the necessary friction between the winch drum and the rope. Such a winch has a winch crank with a handle, with which the winch drum can be rotated in one direction by the operator (the rope is then pulled), while, when the winch crank rotates in the other direction, the winch crank runs freely or can run freely, in which case the winch drum does not move. During free running, pawls prevent the winch drum from rotating counter to the pulling direction of the rope. In addition, the manual holding of the rope prevents the rope from sliding back over the winch drum and in this way undesirably detaching. In addition to a simple transmission, which has a sprocket on the winch drum with one or two pawls, a common winch often also has a transmission that increases the torque applied to the winch drum by the hand crank for example by way of one or more gearwheels. This corresponds to a transmission with a reduction gear. A transmission having pawls or a transmission having pawls and a reduction gear is referred to as a single-speed transmission.

In these known single-speed manually operated winches, an operator of the winch will have only one hand free for actuating the winch crank, since the second hand is required to hold the rope to be pulled. When the rope is tensioned, it is also not possible to secure the rope to a cleat, since the rope has to be continuously fed on the outgoing side of the winch. In order that an operator can operate the winch crank with both hands, there are what are known as self-tailing winches, which generally have a cleat device above the winch drum, the rope to be actuated being introduced into said cleat device. This cleat device rotates along with the rotation of the winch drum, such that the rope is constantly trapped in a part of the cleat device but can simultaneously run off the drum. The operator then has both hands free in order to actuate the winch crank.

A drawback with this prior art is that the rope to be pulled is constantly fitted in a cleat device of the self-tailing winch. Slacking of the rope, that is to say loosening of rope counter to the pulling direction of the winch, requires first of all the removal of the winch crank from the winch, the moving of the winch crank to its storage site, and then the detachment of the rope from the cleat device, this being relatively complicated on account of the configuration of such cleat devices. Following detachment, the rope part running off has again to be held by at least one of the operator's hands. If the rope now needs to be pulled again, either only one hand is available or the rope first of all has to be placed in the cleat device again. In addition, the winch crank has to be plugged back into the winch. In particular when there is the requirement for constant tensioning or slacking of a rope—for example during a regatta or other wind-optimized sailing—the operating of the winch is relatively time-consuming.

### SUMMARY

Proceeding from this prior art, it would be desirable to have a manually operable winch and an actuating device for the winch, which is particularly quick and easy to operate.

In accordance with the disclosure, an actuating device is provided for a manually actuable winch for operating a line, wherein a first end of an actuating lever is configured to cooperate with the winch, and wherein the actuating lever is substantially elongate. The actuating device according to the disclosure is characterized in that a line deflecting element is attached to the actuating lever at a predefinable distance from the first end of the actuating lever, and in that the actuating lever is connected to a restoring device, with which a predefinable force is exerted on the actuating lever in a predefinable direction.

### BRIEF DESCRIPTION OF THE DRAWINGS

Further embodiments and further advantages of the actuating device of the disclosure are intended to be described in more detail on the basis of the exemplary embodiments illustrated in the drawings, where:

FIG. 1 shows a first actuating device with a winch in a perspective view,

FIG. 2 shows the first actuating device for a winch in a perspective view, and

FIG. 3 shows a second actuating device for a winch.

### DETAILED DESCRIPTION OF ILLUSTRATIVE EMBODIMENTS

The basic idea of the disclosure is that the rope running off can be held by the operator with one or both hands and at the same time it is possible to pull the actuating lever and thus to operate the winch, i.e. to pull the line. To this end, according to the disclosure, the line deflecting element functionally replaces so to speak the handle of the otherwise conventional hand crank on the winch. Accordingly, the winch is actuated with the line running off and no longer, as usual, by hand. The line running off is, to this end, simply pulled by the operator and the tractive forces are conducted into the lever by the line deflecting element. The line to be pulled is, to this end, laid around the line deflecting element on the outgoing side of the winch, such that, when a pull is exerted on the line, it is ensured that the line does not loosen undesirably counter to its pulling direction, and at the same time—with a correspondingly high tractive force applied by the operator—the actuating lever is pulled, and in this way the winch drum rotates as desired. The restoring device ensures that the actuating lever is moved back into a starting position when the operator reduces the tractive force on the rope. This is effected by the operator such that the tractive force on the rope is not reduced so greatly that the rope loosens undesirably, but the actuating lever is moved back into its starting position by the winch running freely. With the actuating device according to the disclosure, a winch is thus particularly easy to operate, since the operator has both hands free for the line. At the same time, the winch is operable, specifically in that the operator holds, pulls or slacks the line. Specifically, pulling takes place according to the disclosure likewise with the line, as was described above. In addition, in this way, the line is also quicker to operate. The previously necessary holding of the line with one hand and simultaneously fetching, plugging into the winch and then rotating the winch crank with the other hand is done away with entirely. The complicated detachment from the cleat device of the self-tailing winch is likewise done away with. Since only one hand is required to actuate the actuating device, the operator has their other hand free for example for steering the boat.

For cooperation with the winch, the first end of the actuating lever is configured for example such that it has a crankpin configured with a star-shaped base. The star-shaped base is often embodied in an octagonal manner. Other connecting methods, too, are conceivable here, for example flange-mounting the actuating lever on a winch shaft or plugging the end into a connector device on the winch shaft.

The actuating device according to the disclosure is furthermore advantageously configured when the actuating lever is able to be attached to one of the two axial ends of the winch, and in that the first end of the actuating lever (34, 74) is configured to actuate the winch (12). A winch is usually fastened by a first axial end—specifically one of the two end sides of the approximately cylindrical basic form of the winch—for example to a baseplate on the boot hull. At the second axial end, the free end side of the winch, the end of the winch shaft is frequently configured as a receptacle for the crankpin of the winch crank. In one configuration of the actuating device according to the disclosure, the drive shaft of the actuating device has for example a star-shaped base, and the latter is plugged into this receptacle. In this way, boats having already installed winches are able to be retrofitted particularly easily with the actuating device according to the disclosure. It is also possible to install the actuating device at the first axial end of the winch. Then, the baseplate of the existing winch is mounted on a drive shaft, configured as a fastening plate, of the actuating device, wherein the actuating device is connected to the boat. The advantage here is that the actuating lever is not an obstacle when the line is laid in preparation for operating the winch.

The actuating device according to the disclosure is also characterized in that the first end of an actuating lever is connected to an actuating transmission, and in that the actuating lever is connectable to the winch with the actuating transmission connected in between, and is thus configured to cooperate with the winch. In this way, a particularly compact design of the actuating device with additional functions is created. Thus, in a simple configuration, the actuating transmission can have for example pawls that allow an actuating transmission shaft—for example also the fastening plate—to rotate only in one direction, while free running occurs in the other direction of rotation. This substantially already corresponds to the functions of the single-speed winch. In addition, the actuating transmission can also have a speed reduction. Then, the rotational speed or the torque introduced into the actuating transmission is converted into a lower rotational speed or a greater torque, respectively, at the winch drum for pulling the rope. If appropriate, for certain applications, a speed increase can also be considered. For this purpose, different kinds of actuating transmissions come into consideration, for example actuating transmissions with pawls and a sprocket, actuating transmissions with pawls, gearwheels and a sprocket, or actuating transmissions planetary transmission.

If an existing winch is intended to be retrofitted with the actuating device according to the disclosure, provision is advantageously made for the actuating transmission to be arranged in an actuating device housing, for connecting means to be provided, which make it possible to connect an output shaft to the winch, and for connection means to be provided on the actuating device housing, which make it possible to connect the actuating device housing (30) to the installation site of the winch (12). In this case, it is particularly advantageous for an existing winch not to have to be modified, but merely to be attached to the actuating device. The actuating device housing itself is in this case mounted at the original installation site of the existing winch, for example using screws as connection means, which are plugged through drilled holes in the actuating device housing and are screwed into the installation site. For connecting an output shaft of the actuating transmission to the winch, there are in principle two possibilities.

Firstly, the output shaft can be connected to the winch shaft by the connecting means in order to ensure torque transmission from the actuating device to the winch. In this case, the actuating device housing is also connected to the winch housing.

Secondly, it is also possible to connect the output shaft to the winch housing by the connecting means. Thus, it is possible for example to configure the output shaft on the end side facing the winch as a disk, to which a housing baseplate of the winch is screwed by means of threaded screws as connecting means. In this case, the entire winch is rotated with the actuating device according to the disclosure. Here, all the functions of the original winch are advantageously retained, for example the winch can also be operated additionally with a hand crank. In both cases, the actuating device according to the disclosure is interposed between the original winch and the installation site thereof.

A particularly advantageous actuating device is characterized in that the line deflecting element is a deflecting pin, a roller, a plain bearing or an eyelet. In particular a roller with plain bearing support or rolling bearing support is advantageous from the point of view of line guidance and low bearing friction. It is also advantageous when the deflection axis or the deflection shaft of the line deflecting element lies parallel to the output shaft or to the winch shaft. Then, the line guidance by the winch and about the line deflecting element is particularly favorable. With the distance between the position of the line deflecting element on the actuating lever and the first end of the actuating lever, the torque that is exerted in the case of a predefined tractive force on the line deflecting element for example by the line the actuating lever on the drive shaft of the actuating device is additionally settable. The greater the distance, the greater the torque introduced.

In addition, it is advantageous when the actuating lever is intended to be connected detachably to the winch or the actuating transmission. In the event that the winch is not required for a certain time, it is then possible for the actuating lever to be detached such that the working range of the actuating lever is free for another use. In particular in the event that the actuating device according to the disclosure is arranged between the winch the installation site thereof, the drive shaft can be configured in the form of a hollow shaft that is mounted in a bearing pin. The actuating lever is then able to be plugged detachably into a recess in the drive shaft. In this case, the shape of the recess and the shape of the first end of the actuating lever are for example matched to one another, resulting in a form-fitting connection. Similarly, other latching or plug connections are conceivable and within the concept of the disclosure for connecting the actuating lever to the drive shaft. In addition, unintentional detachment of the actuating lever from the drive shaft can be avoided for example by latching or clamping elements.

In a further advantageous configuration of the actuating device, a line cleat is attached to the actuating lever, and the position of the line cleat is chosen such that a line guided over the line deflecting element is able to be clamped in a desired traction direction. The line to be operated is pulled in a particular direction, which is determined by the position of the operator. The line cleat is positioned according to the disclosure such that the line is able to be obtained without problems by the operator, i.e. the actuating device is operable, and is also easy to fix or clamp in the line cleat by the operator, such that the operator can let the line go without the line slacking. Suitable line cleats are for example jam cleats, servo cleats or cam cleats.

In an advantageous further development, according to the disclosure, the actuating lever has slots, which are arranged such that the line cleat is able to be fixed in a desired clamping position and/or clamping direction within an installation range able to be determined by the slots. In this way, the position of the line cleat is able to be adapted to the local conditions, for example a particular position that the user takes up to operate the line. In a particularly favorable design of the actuating lever, the region of the actuating lever in which the slots are arranged is configured in a platelike manner. The shape of the platelike actuating lever region is adapted to the shape of the line cleat and/or adapted to the functional arrangement of the line deflecting element and line cleat.

In a configuration variant of the actuating device, the actuating lever is configured such that the line deflecting element is able to be positioned in a region radially around an axial extent of the winch. Previously used winch cranks have a handle piece that faces away from the radial region around the axial extent of the winch and is arranged outside this region, in order to prevent the handle piece from passing into the region of the line to be pulled and thus impairing the operation of the line. Therefore, the known winch crank shapes are either straight or provided with a curve, which leads away from this radial region in order to further increase the distance between the handle piece and line. According to the disclosure, the line deflecting element is attached preferably on that side of the actuating lever that faces the radial region of the winch. In addition, the actuating lever is designed, for example curved in the direction of the axial extent, such that the line deflecting element lies in the radial region around the axial extent of the winch. As a result, the guiding of the line between the winch, the line deflecting element and the operator is optimized.

A further advantageous configuration of the actuating device is characterized in that the restoring device is a spring element, a coil spring, a spiral spring, a flat spiral spring, a rubber cord or a rubber band, in that one end of the restoring device is connected to the actuating lever, and in that the other end of the restoring device is connected to a stationary fastening means. If for example a rubber cord or a rubber band is used, a restoring device that is technically particularly simple is able to be realized. This is because the rubber cord or the rubber band is then used as a restoring device in that, for example, one end of the rubber cord is attached to the actuating lever, while the other end of the rubber cord is connected to a suitable fixed point on the boat, for example the deck of the boat. The length of the cord and the spring characteristics of the cord are chosen such that a sufficient restoring force acts on the actuating lever and also pivoting of the actuating lever in the working range thereof is allowed. The position of the stationary fastening means, for example a fitting of the boat, a securing cleat or some other fastening element, on the boat is selectable substantially freely. A particularly good position for the stationary fastening means is achieved, however, when the rubber cord is approximately 90° to the actuating lever and is ideally arranged in precisely the opposite direction to the traction direction of the pulled line. Since this ideal position of the rubber cord changes as a result of the pivoting of the actuating lever, it is already advantageous for said 90° to be achieved in a position within the pivoting range of the actuating lever. A spiral spring is also advantageously usable for a restoring device. The advantage of this is that the spiral spring is arrangeable in particular in the region of the first end of the fastening lever. In this way, the restoring device is realized in a particularly space-saving manner.

It is particularly favorable according to the disclosure for the fastening means for fastening the spring element to be attached to a winch axle, a winch housing, a fitting element at the installation site of the winch, an immovable actuating device component, or to some other fixed component.

In a development of the subject matter of the disclosure, the actuating transmission has a drive shaft and an output shaft, the axes of rotation of which are parallel, and said actuating transmission is configured such that the drive shaft that is actuated by the actuating lever and the output shaft that is able to cooperate with the winch rotate in different directions of rotation. In this way, with the actuating device, a direction of rotation reversing transmission is also realized, which reverses the direction of rotation of the winch. This is advantageous in particular when, for example, all the winches on board a sailboat are intended to be operated in the same direction of rotation, in particular in the clockwise direction, when the winch is seen in plan view. For the starboard side of a sailboat, the line to be pulled is then laid around the winch beginning likewise in the clockwise direction, resulting in advantageous line guidance of the line to be pulled in the direction of the boat hull. When a winch rotating in the same direction is used for the port side of the sailboat, the line guidance is correspondingly more unfavorable, since the pulled line lies between the winch and the boat interior. In this case, it is advantageous to use for the port side an actuating device having a direction of rotation reversing transmission. The line to be pulled is then advantageously guided between the winch and the vessel's side on the port side, too, and at the same time the winch is operated in the clockwise direction. Although the use of winches with different directions of rotation on the starboard side and the port side is also possible, it is unconventional for operating reasons.

Furthermore, provision is made for a pivoting movement of the actuating lever to be limited to a predefinable maximum angular range of between 30 degrees and 180 degrees. In this way, a pivoting range for the pivoting movement of the actuating lever is predefined, making it easier to operate the actuating device. It is appropriate to limit the pivoting range to 30° when the spatial conditions for actuating the actuating lever are confined. Pivoting up to an angular range of 180° is still feasible especially for the operator of the winch. However, a preferred angular range for pivoting should be considered as being between 80° and 150°. Here, the force transmission via the line deflecting element into the actuating lever via the line running off by the pulling of the operator is considered to be preferred on account of the favorable geometric conditions.

The pivoting movement is advantageously limited when the angular range is limited structurally by a corresponding opening in the actuating device housing or is able to be limited by stop elements.

The opening limitation is settable in a particularly variable manner when the actuating device, characterized in that a first actuating device housing component having the opening (32) about its imaginary central axis (50) relative to a second actuating device housing component, which is provided for connecting to the stationary installation site of the actuating device housing (30), and in that the first and second actuating device housing components are able to be connected firmly together in a chosen position by latches, pins or other positioning means. In this way, the orientation of the opening and thus the pivoting range of the actuating lever are adaptable particularly easily to the conditions at the installation site. First of all, the second actuating device housing component is installed at the chosen stationary installation site, for example the boat deck. Then, the opening in the first actuating device housing component is moved in a desired direction in that the first actuating device housing component is rotated relative to the second actuating device housing component. Once the desired position of the opening has been reached, the first and second actuating device housing components are connected firmly together for example by latching elements, such that they can no longer rotate relative to one another. For example, after (initial) installation has taken place, the position of the opening can be changed again only by releasing the latching elements. In this way, it is possible to change in retrospect, i.e. if required. Accordingly, the actuating device of this configuration variant is usable in a particularly flexible manner.

The object of the disclosure is also achieved by a winch having an actuating device according to the disclosure, which has configuration features as described above and in the claims. It is particularly advantageous here that the advantages of the active device according to the disclosure are incorporated in a winch. This allows a particularly compact design of the winch and makes it possible to optimize or minimize the number of necessary components of the winch.

In a particularly advantageous configuration of the winch according to the disclosure, the actuating transmission is arranged at least partially in a winch housing. In this way, essential parts of the actuating device are arrangeable in the winch itself, thereby ensuring that the winch then has the features according to the disclosure. Thus, for example, the opening for limiting the working range of the actuating lever is arrangeable in the winch housing and/or the output shaft of the actuating device is able to be configured as a winch drum. The structure of the winch is simplified in a corresponding manner. In addition, it is also possible for the restoring device to be arranged in the winch housing, in particular when a spiral spring or a coil spring is used as the restoring element in the restoring device.

When the technical features of the actuating device are incorporated in the winch, there is also the advantage that not only is the angular range able to be limited structurally by a corresponding opening in the winch housing but also the angular range is able to be limited by limiting elements on the winch housing. Here, the opening in the winch housing limits the pivoting range of the actuating lever in a mechanically simple manner.

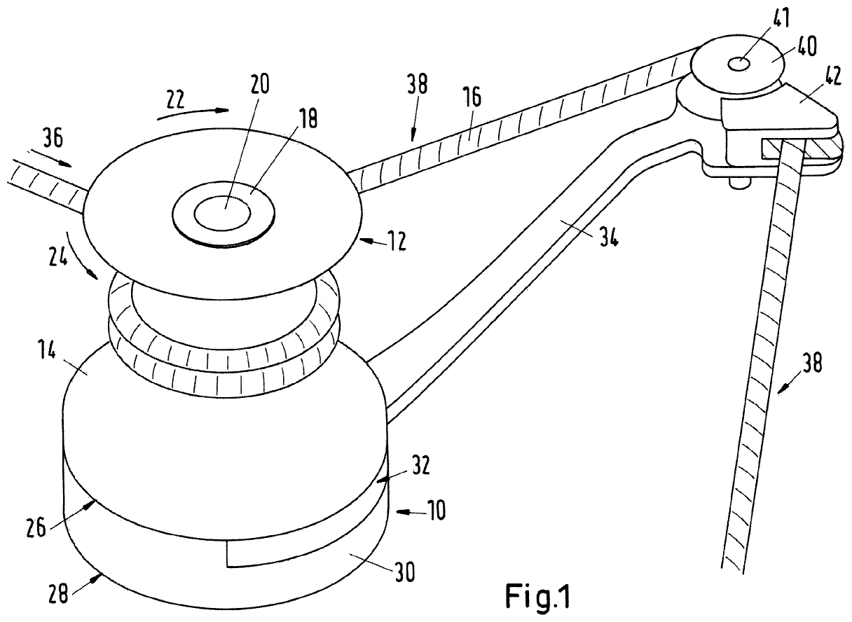

FIG. 1 shows a perspective view of a first actuating device 10 according to the disclosure, which is attached to a winch 12. The winch 12 has a winch drum 14, about which a line 16 has been laid with two coils in the clockwise direction in a plan view of the winch 12. The winch 12 has a winch shaft 18, which, on the end side visible in the figure, has a recess 20 provided for the plugging in of a winch crank (not illustrated in the figure) generally in a form-fitting manner. The rotating of the winch crank in the clockwise direction, indicated by a first arrow 22, causes the winch shaft 18 together with the winch drum 14 to also be rotated in the clockwise direction. Driver elements in a winch drive, also known as a winch transmission, entrain the winch drum 14 in the clockwise direction, a first direction of rotation of the winch drum 14. Although the rotating of the winch crank in the counterclockwise direction, indicated by a second arrow 24, causes the winch shaft 18 to be rotated counterclockwise, the winch drum 14 remains in its rotational position, since the driver elements, for example blocking elements, for example pawls, of the winch drive in the interior of the winch 12—i.e. not visible in this figure—prevent the winch drum from rotating in the direction of the second arrow 24. The movement of the winch shaft 18 in the direction of the second arrow 24 is also referred to as free running. This design of the winch 12 is known as a single-speed winch or manually operated single-speed winch. Two-speed and multi-speed winch forms also exist, which have a correspondingly more complicated drive or a more complicated transmission, wherein different gears have different transmission ratios between the drive side of the winch, the winch shaft 18, and the output side of the winch, the winch drum 14. In the single-speed form, too, the winch drive is configured as a transmission, which, in addition to the function of blocking a direction of rotation, can also have a speed reduction. A speed reduction is achieved when a particular number of revolutions of the winch shaft 18 is converted into a lower number of revolutions of the winch drum 18. In this way, torques or forces acting on the winch are increased or reduced, in order to ensure more convenient operability of a manually operable winch.

Using the winch 12, the line 16 is operable, i.e. as a result of the rotation of the winch drum 14, the line 16 is able to be pulled in the direction of the third arrow 36. If the line 16 is intended to be operated counter to this direction, the line 16 is simply detached and, by way of the force that acts on the line 16 counter to the direction of the third arrow 36, the line then moves counter to the direction of the third arrow. The force is applied for example by a headsail of a sailboat, which is connected to the line 16. The winch drum 14 does not rotate in the process, as already explained in detail above, and so the line is pulled over the surface of the fixed winch drum 14.

In the exemplary embodiment shown, the winch 12 is mounted on a disklike plate on a top side 26 of the first actuating device 10 and is connected to the first actuating device 10 in this way. A baseplate as a first actuating device housing component of the actuating device housing 30 on an underside 28 of the first actuating device 10 is then connected firmly to a fixed component, in particular a deck of a sailing yacht. The actuating device housing 30 has an opening 32 in a second actuating device housing component having a tubular side wall, through which a first actuating lever 34 engages with a first end. A second end of the first actuating lever 34 is connected to a first restoring device, which is not illustrated in this figure, but has a spring element that ensures that a restoring force that is predefinable by the chosen spring strength acts on the first actuating lever 34. In this case, the restoring force acts in the direction of the second arrow 24. A line portion 38 running off the winch drum 14 is in this case guided over a roller 40 as line deflecting element, which is attached to a second end of the first actuating lever 34. In the example shown, the roller 40 is mounted on a roller pin 41. By way of the roller 40, the line portion 38 running off is guided unambiguously between the winch drum 14 and the roller 40, while the traction direction in which the line portion 38 is pulled is selectable substantially freely. However, it is ideal when the line portion 38 running off exhibits, in its further course, approximately an angle of 90° to the first actuating lever 34, since then, with the tractive force of the line, favorable force transmission into the first actuating lever 34 is able to be generated in order that an advantageous torque is able to be introduced into the winch drum 14.

FIG. 1 also shows a jam cleat 42 as cleat element for the line 16, which is likewise attached at the second end of the first actuating lever 34. The position of the line cleat 42 on the first actuating lever 34 is chosen such that the line 16 can be detached easily from the cleat, but is also easy to secure in the cleat. In this way, the portion 38 of the line 16 that is running off does not have to be held constantly by an operator, for example a sailor, in order that the line does not detach counter to the traction direction according to the third arrow 36. In order to detach from the cleat, the line portion 38 running off is moved to the right in this figure by the operator, such that the line portion 38 moves out of the jam cleat 42, which is open to the right.

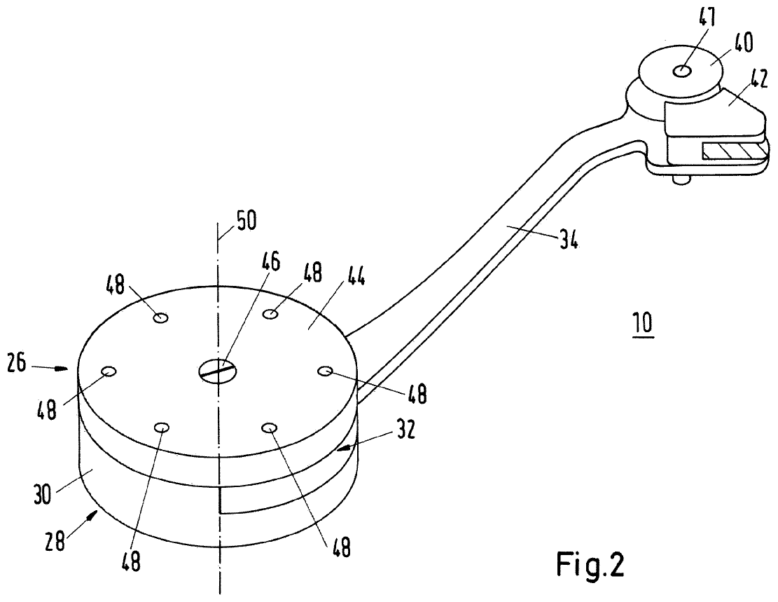

FIG. 2 shows the first actuating device 10 for a winch in a perspective view. In the figure, those components that are also shown in FIG. 1 are provided with the same reference signs. A winch is able to be installed on the disklike plate, a cover plate 44, on the top side 26 of the actuating device 10. To this end, the cover plate 44 is configured as a disklike plate and is connected by way of a screw 46 to an output shaft (not illustrated in the figure) of an actuating device transmission of the actuating device 10. In this way, the cover plate 44 is part of the output shaft and, depending on the configuration of the cover plate 44, the latter can also be considered to be the output shaft itself. The cover plate 44 can also be configured in a bell-shaped manner, however. In any case, it is advantageous when a sprocket is arranged on the disklike or bell-shaped plate, on the side facing toward the interior of the actuating device transmission. When the first actuating lever 34 is actuated or pivoted, the actuating device transmission is driven and thus the cover plate 44 also rotated. For connecting to the winch, six threaded holes 48 are arranged in the cover plate 44. In this way, it is particularly easy to screw a base plate of a winch to the cover plate 44 by means of screws. In this case, the pattern or distribution of the threaded holes 48 both in terms of number and in terms of position is adaptable easily to the corresponding number and position of holes in the baseplate of the winch. Equally, a large number of threaded holes can be present in the cover plate 44 and positioned such that different winch types are able to be mounted on one and the same cover plate. In the example shown, provision is made for a winch to rotate with the actuating device 10 as a unitary component, as soon as said winch is connected to the cover plate 44. As a result of the rotation of the winch, the latter is then also operable for the purpose of pulling a rope. It is also apparent that the opening 32 is formed by a recess in the upper edge of a lateral wall of the cylindrical actuating device housing 30. The opening 32 is configured as a slot-like recess in that, in the figure, an upper boundary of a recess in the second actuating device housing component is formed by the cover plate 44. The length of the opening determines the working range of the first actuating lever 34. In this case, the boundaries of the opening 32 along the length thereof serve as stop or limiting elements for the first actuating lever 34. The first actuating lever is in this case pivoted about an imaginary central axis 50 of the actuating device 10, such that the working range thereof passes over an imaginary sector. In a corresponding manner, the opening 32 has a circular segment shape when it is viewed in plan view of the cylindrical actuating device housing 30.

It is also apparent from this figure that the first actuating lever 34 is curved upward in the direction of the central axis 50 in the figure. In this way, the roller 40 is positioned in an imaginary radial region around the winch housing, which is intended to be mounted on the cover plate 44.

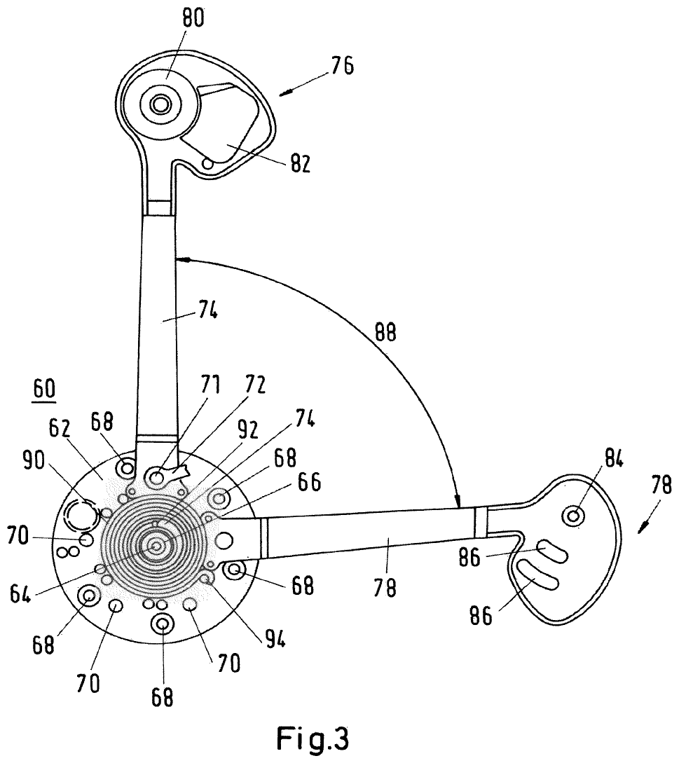

FIG. 3 shows a second actuating device 60 in plan view as seen from a winch to be mounted, wherein a cuplike shaft end and an actuating transmission are not shown. A winch is then able to be mounted on the cuplike shaft end. Shown in this plan view is a mounting plate 62, on which a shaft bearing pin 64 has been mounted, in which a drive shaft 66 of the second actuating device 60 is supported. A plurality of through-holes 68 have been introduced into the mounting plate 62, said through-holes 68 being used to connect the mounting plate 62 to a fixed object, for example the deck of a sailing yacht, by way of connecting means, for example by means of screws. In addition, several pins 70 are connected to the mounting plate 62. Pawls are able to be plugged onto these pins 70 and mounted in a rotatable manner in this way. These pawls have the purpose of preventing the cuplike shaft end from rotating during free running. To this end, the pawls engage at their free ends in a gearwheel, which is either integrally formed on or attached to the inner side of the cuplike shaft end. In addition, a drive pawl or dog 72 is also shown on a bearing pin 71 on a second actuating lever 74. In the assembled state of the second actuating device 60, the dog 72 likewise engages in the gearwheel and drives the latter, by the pivoting of the second actuating lever 74, in the drive direction together with the cuplike shaft end. In the assembled state, pawls have been plugged onto one, two or several of the pins 70.

The drive shaft 66 is connected to the cuplike shaft end, wherein the latter is mounted in a rotatable manner as a result. The second actuating lever 74 is pivoted and thus drives the cuplike shaft end via the sprocket, as described above. The second actuating lever 74 is shown in a first 76 and a second actuating position 78, wherein a deflection roller 80 as line deflecting element and a cleat element 82 in the second position are not shown, such that, in the second position 78, a through-hole 84 and slots 86 are visible, which are provided for fastening the deflection roller 80 or for mounting the cleat element 82. For example, by means of screws, the cleat element 82 and the deflection roller 80 are then able to be connected to the second actuating lever 74.

The mounting position of the cleat element 82 is freely selectable in the region of the slots 86. A maximum pivot angle 88, which is limited by the two actuating positions 76, 78, is about 90° in the example chosen. The pivot angle 88 can be limited by components or slits in the housing or by other limiting means. It has been found here that a maximum pivot angle of between 45° and 150° is particularly advantageous. However, maximum pivot angles of 30° to 180° are also readily conceivable. Although maximum pivot angles of more than 180° are readily conceivable mechanically, problems then arise in practice when pulling the line during operation of an actuating device together with a winch.

In the example shown, the restoring device for the second actuating lever 74 has a spiral spring 90, the shape of which is formed from a striplike spring steel rolled up into a spiral. In this case, the radially inner end of the spiral spring 90 is fastened in a groove 92 in the second actuating lever 74. While the radially outer end of the spiral spring 90 is mounted around a retaining pin 94, which is firmly connected to the mounting plate 62. In this way, the spring transmits the spring forces to a fixedly mounted component, while the spring forces likewise act on the second actuating lever 74. If no forces otherwise act on the actuating lever, the spiral spring 90 has the effect that the second actuating lever 74 remains in or is moved into its first actuating position 76.

1. An actuating device for a manually actuable winch for operating a line, the actuating device comprising:
an actuating lever having a first end configured to cooperate with the winch, and wherein the actuating lever is substantially elongate,
a line deflecting element attached to the actuating lever at a predefinable distance from the first end of the actuating lever, and
a restoring device connected to the actuating lever, the restoring device exerting a predefinable force on the actuating lever in a predefinable direction.

2. The actuating device as claimed in claim 1, wherein the actuating lever is configured to be attached to one of two axial ends of the winch (12), and wherein the first end of the actuating lever is configured to actuate the winch.

3. The actuating device as claimed in claim 1, further comprising an actuating transmission and wherein the first end of the actuating lever is connected to the actuating transmission, and wherein the actuating lever is connectable to the winch, with the actuating transmission connected in between.

4. The actuating device as claimed in claim 3, wherein the actuating transmission is arranged in an actuating device housing, wherein connecting means connect an output shaft to the winch, and connection means on the actuating device housing connect the actuating device housing to an installation site of the winch.

5. The actuating device as claimed in claim 1, wherein the line deflecting element is a deflecting pin, a roller, a plain bearing or an eyelet.

6. The actuating device as claimed in claim 1, wherein the actuating lever is detachably connected to the winch or the actuating transmission.

7. The actuating device as claimed in claim 1, wherein a line cleat is attached to the actuating lever, and wherein the position of the line cleat is such that a line guided over the line deflecting element is able to be clamped in a desired traction direction.

8. The actuating device as claimed in claim 7, wherein the actuating lever has slots, which are arranged such that the line cleat is fixable in a desired clamping position and/or clamping direction within an installation range determined by the slots.

9. The actuating device as claimed in claim 1, wherein the actuating lever is configured such that the line deflecting element may be positioned in a region radially around an axial extent of the winch.

10. The actuating device as claimed in claim 1, wherein the restoring device is a spring element, a coil spring, a spiral spring, a flat spiral spring, a rubber cord or a rubber band, wherein one end of the restoring device is connected to the actuating lever, and the other end of the restoring device is connected to stationary fastening means.

11. The actuating device as claimed in claim 10, wherein the fastening means is attachable to a winch axle, a winch housing, a fitting element at the installation site of the winch, an immovable actuating device component, or to some other fixed component.

12. The actuating device as claimed in claim 3, wherein the actuating transmission has a drive shaft and an output shaft, the axes of rotation of which are parallel, and wherein said actuating transmission is configured such that the drive shaft, which is actuated by the actuating lever and the output shaft, which cooperates with the winch, rotate in different directions of rotation.

13. The actuating device as claimed in claim 1, wherein a pivoting movement of the actuating lever is limited to a predefinable maximum angular range of between 30 degrees and 180 degrees.

14. The actuating device as claimed in claim 13, further comprising an actuating device housing and wherein the angular range is limited structurally by a corresponding opening in the actuating device housing.

15. The actuating device as claimed in claim 14, wherein the actuating device housing includes a first actuating device housing component having the opening and a second actuating device housing component for connecting to the stationary installation site of the actuating device housing, and wherein the first and second actuating device housing components are able to be connected firmly together in a chosen position by latches, pins or other positioning means.

16. In combination, a winch and an actuating device as claimed in claim 1.

17. The combination as claimed in claim 16, wherein the actuating device includes an actuating transmission arranged at least partially in a winch housing.

18. The combination as claimed in claim 16, wherein the angular range is limited structurally by a corresponding opening in the winch housing or limiting elements on the winch housing.

19. The combination of claim 16, wherein the winch further comprises a winch drum about which a portion of the line may be coiled, the winch drum being disposed above a housing component of the actuating device, wherein the housing component at least partially defines an opening through which the actuating lever extends, and wherein the actuating lever extends upwardly and outwardly such that the line deflecting element is disposed outward from the winch in a radial direction extending from a center axis of the winch.

20. The combination of claim 19, wherein the actuating lever is pivotable between first and second positions, wherein the actuating lever is connected to the winch drum such that the pivoting of the actuating lever from the first position toward the second position causes the winch drum to rotate, whereas the pivoting of the actuating lever from the second position toward the first position does not cause the winch drum to rotate, and wherein the actuating lever is biased toward the first position.
